(19) United States
(12) Patent Application Publication
(10) Pub. No.: US 2015/0134509 A1
(43) Pub. Date: May 14, 2015

(54) IDENTIFICATION OF DIRECT DEPOSIT PARTICIPANTS

(71) Applicant: BANK OF AMERICA CORPORATION, Charlotte, NC (US)

(72) Inventors: Jason M. Martin, Charlotte, NC (US); Cathy Rodgers, Denver, NC (US)

(73) Assignee: BANK OF AMERICA CORPORATION, Charlotte, NC (US)

(21) Appl. No.: 14/078,961

(22) Filed: Nov. 13, 2013

(51) Int. Cl. G06Q 20/10

(52) U.S. Cl. CPC G06Q 20/10
USPC 705/39

(57) ABSTRACT

Embodiments of the invention are directed to systems, methods and computer program products for identifying participating employers in a direct deposit program. In some embodiments, a system is configured to: receive a first information from a user, wherein the first information includes an employer name; compare the received employer name to a database of employer names that participate in a direct deposit program; determine a match between the received employer name and an employer name that participates in a direct deposit program; and prompt the user with an offer to enroll in a direct deposit program via an interface, in response to determining a match.

### BACKGROUND

There is a need to enable a user to quickly and efficiently identify participating employers in a direct deposit program.

### BRIEF SUMMARY

In some embodiments, an apparatus for identifying participating employers in a direct deposit program is provided. The apparatus comprises: a memory; a processor; and a module stored in memory, executable by the processor, and configured to: receive a first information from a user, wherein the first information includes an employer name; compare the received employer name to a database of employer names that participate in a direct deposit program; determine a match between the received employer name and an employer name that participates in a direct deposit program; and prompt the user with an offer to enroll in a direct deposit program via an interface, in response to determining a match.

In some embodiments, the first information is received via at least one of a wireless network, the Internet, and a satellite network.

In some embodiments, the employer name includes a string of text characters.

In some embodiments, prompting the user with an offer to enroll in a direct deposit program further comprises enrolling an account associated with the user in the direct deposit program.

In some embodiments, the user may select which account to enroll in the direct deposit program.

In some embodiments, the user may select multiple accounts to enroll in the direct deposit program.

In some embodiments, the account is at least one of a savings account, a checking account, and an investment account.

In some embodiments, enrolling the account associated with the user comprises enrolling the account using a third party payroll provider.

In some embodiments, comparing the received employer name to a database of employer names that participate in a direct deposit program comprises transmitting the employee name to a second apparatus for processing.

In some embodiments, the second apparatus is associated with a financial institution.

In some embodiments, the second apparatus is associated with a third party payroll provider.

In some embodiments, transmitting the employer name to a second apparatus further comprises transmitting information associated with the employer.

In some embodiments, comparing the received employer name to a database of employer names that participate in a direct deposit program comprises comparing one or more strings of text characters.

In some embodiments, the interface includes prefilled information.

In some embodiments, the prefilled information is associated with the employer.

In some embodiments, the prefilled information is associated with the user.

In some embodiments, the prefilled information is associated with an account associated with the user.

In some embodiments, in response to determining that there is no match between the received employer name and an employer name that participates in a direct deposit program the received employer name is input to the database.

In some embodiments, a method for identifying participating employers in a direct deposit program is provided. The method comprises: receiving a first information from a user, wherein the first information includes an employer name; comparing the received employer name to a database of employer names that participate in a direct deposit program; determining a match between the received employer name and an employer name that participates in a direct deposit program; and prompting the user with an offer to enroll in a direct deposit program via an interface, in response to determining a match.

In some embodiments, a computer program product for identifying participating employers in a direct deposit program is provided. The computer program product comprises a non-transitory computer-readable medium comprising code causing a computer to: receive a first information from a user, wherein the first information includes an employer name; compare the received employer name to a database of employer names that participate in a direct deposit program; determine a match between the received employer name and an employer name that participates in a direct deposit program; and prompt the user with an offer to enroll in a direct deposit program via an interface, in response to determining a match.

### BRIEF DESCRIPTION OF THE DRAWINGS

Having thus described embodiments of the invention in general terms, reference will now be made to the accompanying drawings, where:

FIG. 1 is a general process flow for identifying participating employers in a direct deposit program, in accordance with embodiments of the present invention;

FIG. 2 is a general process flow for enrolling in a direct deposit program via a third party payroll provider, in accordance with embodiments of the present invention;

FIG. 3 is an exemplary user interface for a payroll summary, in accordance with embodiments of the present invention;

FIG. 4 is an exemplary user interface for editing direct deposit information, in accordance with embodiments of the present invention;

FIG. 5 is an exemplary user interface for signing into online banking, in accordance with embodiments of the present invention;

FIG. 6 is an exemplary user interface for authenticating entry into online banking, in accordance with embodiments of the present invention;

FIG. 7 is an exemplary user interface for a wait message, in accordance with embodiments of the present invention;

FIG. 8 is an exemplary user interface for selecting a bank account, in accordance with embodiments of the present invention;

FIG. 9 is an exemplary user interface for prefilling account information, in accordance with embodiments of the present invention;

FIG. 10 is an exemplary user interface for determining if an employer name participates in a direct deposit program, in accordance with embodiments of the present invention;

FIG. 11 is an exemplary user interface for selecting an account to be enrolled in a direct deposit program, in accordance with embodiments of the present invention;

FIG. 12 is an exemplary user interface for selecting an account to be enrolled in a direct deposit program, in accordance with embodiments of the present invention;

FIG. 13 is an exemplary user interface for presenting a summary of information associated with an employer and/or the user, exemplary user interface for selecting an account to be enrolled in a direct deposit program, in accordance with embodiments of the present invention;

FIG. 14 is an exemplary user interface for reviewing information to be sent to a third party payroll provider for processing, exemplary user interface for selecting an account to be enrolled in a direct deposit program, in accordance with embodiments of the present invention;

FIG. 15 is an exemplary system diagram for executing the present invention, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like.

In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is typically maintained by the entity. In other embodiments, an “entity” may not be a financial institution.

In some embodiments, the “user” may be a customer (e.g., an account holder or a person who has an account (e.g., banking account, credit account, or the like) with the entity), a merchant (e.g., a business, a vendor, a service provider, or the like), or an employee of a business. In some embodiments, the user may have an existing account associated with the entity. In other embodiments, the user may have an existing account associated with another bank. In alternative embodiments, the user may be a new customer. The user may also be an agent (e.g., a customer service representative, an internal operations specialist, a bank teller, an account manager, an IT technician, a database manager, a mainframe operator, or the like) associated with the entity.

The present invention may enable an apparatus (e.g., a computer system) associated with the entity to efficiently enroll the user into a direct deposit program for payroll purposes. Uniquely, the present invention may take advantage of a mutually beneficial relationship between the entity and a third party payroll provider. Because the third party payroll provider primarily deals with payroll services, the entity may utilize the third party payroll provider for processing requests for enrollment into the direct deposit program. Hence, the third party payroll provider, who has access to employer and employee information, may more efficiently process enrollment requests when enrolling the user in the direct deposit program.

Furthermore, the present invention may utilize secure aggregation methods, such as screen scraping, to automatically collect information associated with the user's accounts (a financial account, a checking account, a savings account, an investment account, an account number, a routing number, or the like), as well as employer information. Prefilling the direct deposit enrollment forms with this information may eliminate, for example, the need for the user to physically locate an account number or routing number on a check and input information by hand into direct deposit enrollment forms.

Therefore, the present invention aims to streamline user enrollment into the direct deposit program, which may enable the user to deposit paychecks without having to go to a banking location or an automatic teller machine (ATM). Ease of user enrollment into the direct deposit program may potentially increase direct deposit penetration throughout the entity's customer segments while promoting online banking activity. Through collaboration with the third party payroll provider, enrolling into the direct deposit program may become a more streamlined process.

The present invention may be integrated into an online banking application associated with the entity. The application may enable the user to log in and access an online payroll system, from which the user may enroll into the direct deposit program. Integration of the payroll system in the online application may enable the user to enroll into the direct deposit program without having to visit and visit and log into a third party payroll provider's website.

After logging in and gaining access to the payroll system, the user may be presented with a first interface that displays the user's account and information associated with the user's account. This account information, such as contact information (a name, an address, a phone number, an email, or the like), an account number, a routing number, an amount, or the like may be automatically aggregated by the present invention or manually entered by the user. The apparatus may be further configured to present multiple accounts associated with the user. The user's account may be associated with the entity, or another financial institution.

Via the first interface, the user may select an account from which he wishes to retrieve information for enrollment into the direct deposit program. User authentication may be required upon the user's account selection. For example, the user may be required to provide a username, a password, a passcode, a user identification number, an answer to a security question, or the like. In other embodiments, the present invention may verify the security measures with the selected account. In alternative embodiments, the present invention may forward the authentication attempt to the entity (or another financial institution) for processing.

Upon positive verification of the user, the present invention may automatically retrieve information associated with the user's account (e.g., an account number, a routing number, contact information, or the like). In some embodiments, the present invention may utilize secure industry aggregation methods, such as screen scraping, to locate and obtain the requested account information. The present invention may retrieve information from a database associated with the entity or a third party payroll provider. Once retrieved, the account information may be stored in a database (e.g., a datastore, a server, or the like) and may be recalled for later use.

In some embodiments, the present invention may be configured to automatically identify the user's employer while processing the retrieved information. The employer's name may be included in the retrieved account information, manually input by the user, or collected via another method and may exist as text or a string of characters. After the present invention identifies the employer name, the present invention may be configured to automatically compare the user's employer name against a database of employer names. The database of employer names may include the names of employers who have already established a direct deposit program and may be used to determine if the user's employer participates in a direct deposit program. Upon positive determination, the present invention may prompt the user with an offer to enroll in the direct deposit program. Fields of information pertinent to the employer's direct deposit program's enrollment process, such as information associated with the employer or an account, may be prefilled by the present invention and presented to the user. In some embodiments, the database of employer names may be associated with the entity. In other embodiments, the database of employer names may be associated with the third party payroll provider, so the employer name may be transmitted to the third party payroll provider for processing.

Typically, the present invention presents retrieved account information to the user via a second interface. The second interface may be prefilled with account information associated with the user's account. The second interface may enable the user to select into which account(s) are to be enrolled in the direct deposit program. In some embodiments, the user may select one account to enroll in the direct deposit program. In other embodiments, the user may select multiple accounts. In alternative embodiments, the user may select different types of accounts including at least one of a checking account, a savings account, an investment account, or the like.

After the user selects the account(s) to be enrolled in the directly deposit program, the present invention may present to the user a third interface that summarizes the pending direct deposit program enrollment. Information associated with the selected account(s) may include an account type, a routing number, a transit number, an account number, a financial institution, an amount, a percent, a remaining balance, or the like. In some embodiments, the account information displayed in the third interface may be prefilled by the apparatus.

From the third interface, the user may then select how much of his paycheck is to be directly deposited into each selected account. For example, the user may wish to directly deposit ten percent of his paycheck into a savings account while directly depositing the remaining ninety percent into a checking account. Conversely, the user may wish to directly deposit all of his paycheck into one account. The user may allocate his paycheck using a numerical dollar amount, a percent of the paycheck, a remaining balance, or the like. Furthermore, the user may be enabled to change, edit, modify, add, or delete the allocation of funds into each account at any time via the third interface.

The user may review the prefilled information associated with the selected direct deposit accounts and then submit the account information to continue the enrollment process. In some embodiments, the user may be required to verify that the prefilled information is indeed correct. In other embodiments, the user may be required to verify that he agrees to terms and conditions associated with the direct deposit program.

Upon submission, the present invention may uniquely transmit the user's request to enroll at least one account into the direct deposit program, as well as information associated with the user's selected account, to a third party payroll provider for processing. The third party payroll provider may process the request for enrollment and associated account information. Processing the request and associated information may include enrolling the user's accounts into the direct deposit program. Because the third party payroll provider typically has access to large amounts of information associated with various financial entities and employers, processing the direct deposit enrollment requests via a third party payroll provider may increase efficiency while minimizing time and costs of enrollment. Once the enrollment has been approved and instated by the third party payroll provider, direct deposit may take effect for the user's next payroll cycle.

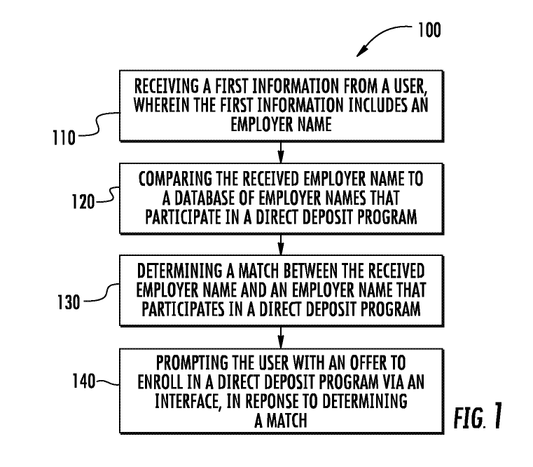

FIG. 1 illustrates an exemplary process flow 100 for identifying participants in a direct deposit program. At block 110, the process includes receiving a first information from a user, wherein the first information includes an employer name. At block 120, the process includes comparing the received employer name to a database of employer names that participate in a direct deposit program. At block 130, the process includes determining a match between the received employer name and an employer name that participates in a direct deposit program. At block 140, the process includes prompting the user with an offer to enroll in a direct deposit program via an interface, in response to determining a match.

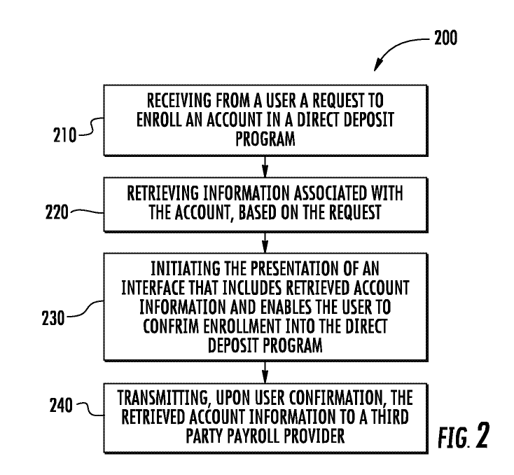

FIG. 2 illustrates an exemplary process flow 200 for third party processing of a request for direct deposit. At block 210, the process includes receiving from a user to enroll an account in a direct deposit program. At block 220, the process includes retrieving information associated with the account based on the request. At block 230, the process includes initiating the presentation of an interface that includes retrieved account information and enables the user to confirm enrollment into the direct deposit program. At block 240, the process includes transmitting, upon user confirmation, the retrieved account information to a third party payroll provider.

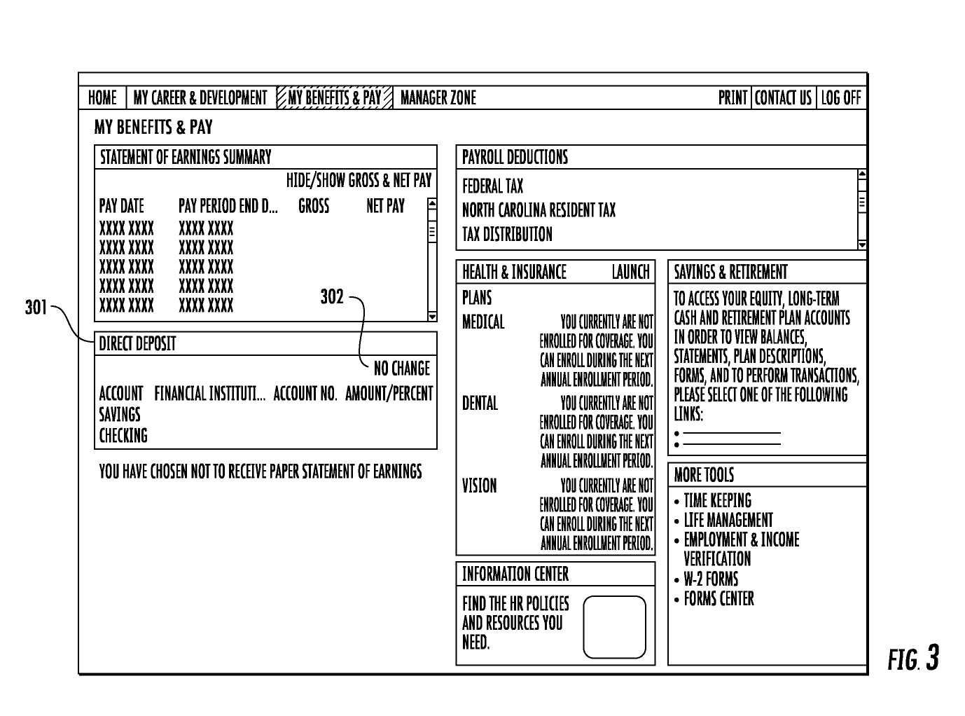

FIG. 3 illustrates an exemplary user interface for a payroll summary. The exemplary user interface in FIG. 3 may be presented to the user once the user has logged into his or her payroll provider's portal. The payroll summary may include benefits and pay and a summary of earnings, payroll deductions, or the like. Furthermore, a summary of direct deposit activity 301 may be presented to the user. By selecting the Change 302 button, the user may manage how his paycheck is directly deposited into one or more of his accounts.

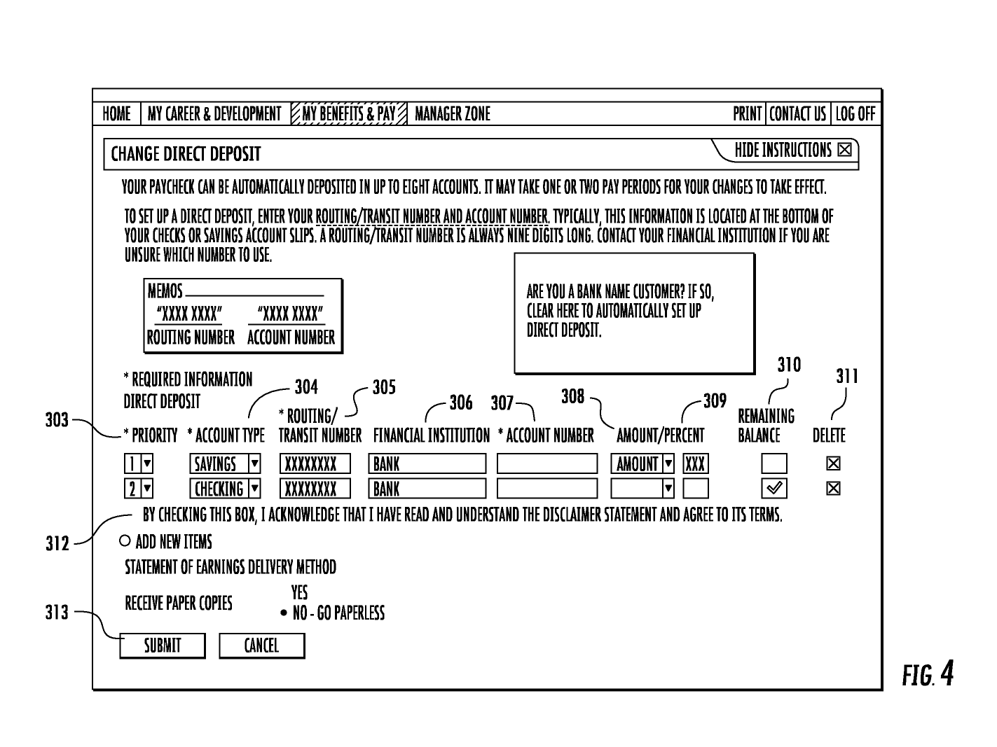

After the user selects the Change 302 button, the apparatus may present to the user an exemplary user interface for editing direct deposit information as shown in FIG. 4. The user may view a summary of his accounts that are configured to accept direct deposit payments. Items in the summary view may include a priority 303 associated with each account, an account type 304, a routing or transit number 305, a financial institution name 306, an account number 307, an amount of the paycheck allocated to each account 308, a percentage of the paycheck amount allocated to each account 309, an option to allocate the remaining balance of a paycheck to each account 310, or a Delete 311 button. The user may agree 312 to terms and conditions associated with enrolling in the direct deposit program. The interface may also include instructions for how to enroll into the direct deposit program, how to edit information associated with the user's accounts, or the like. The user may also select to automatically enroll in the direct deposit program. The user may select the Submit 313 button to submit his information into the direct deposit program.

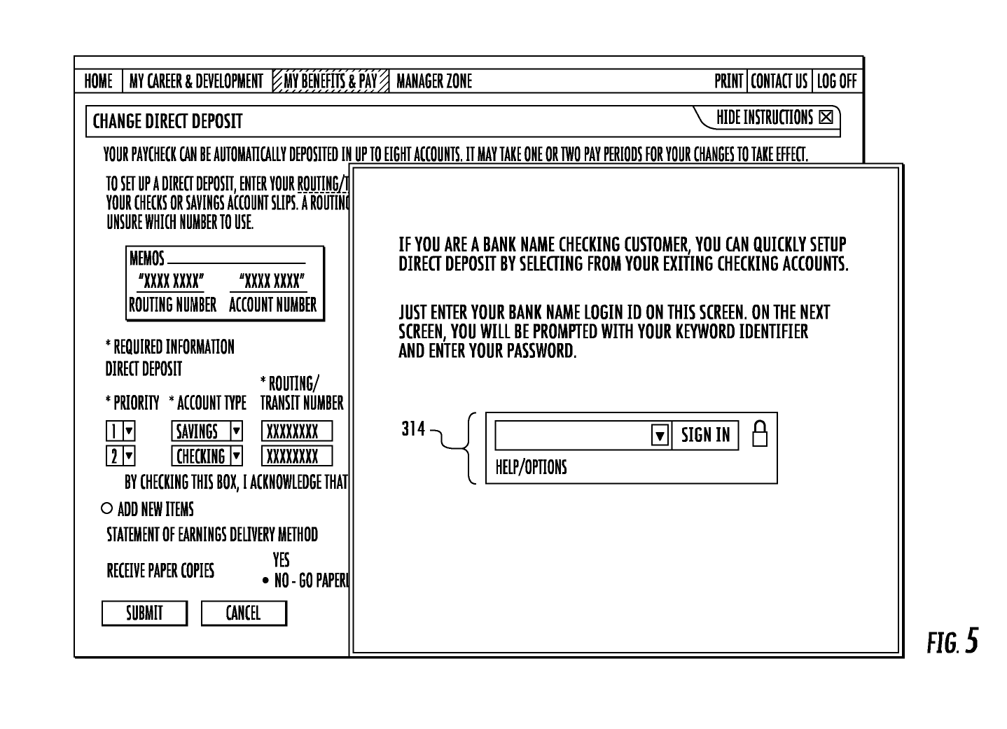

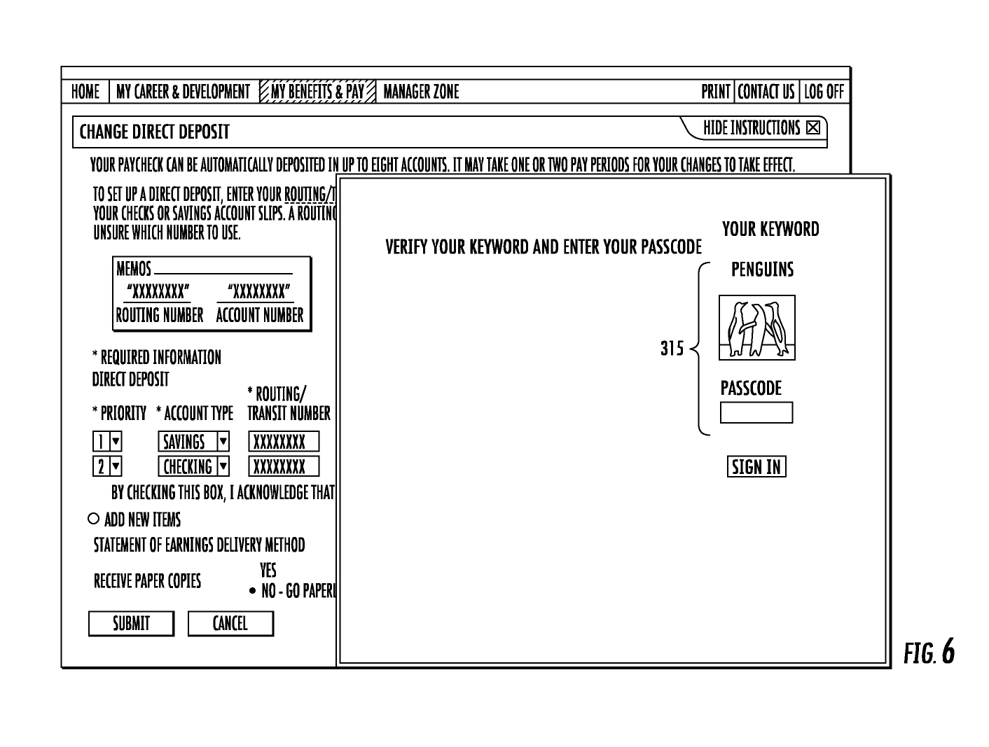

If the user wishes to automatically enroll in the direct deposit program, he may be prompted by the apparatus to sign into online banking account as illustrated in FIG. 5. By entering in his online banking username 314, the user may begin the automatic enrollment process. The user may also be prompted by the apparatus to enter authentication 315 associated with his online banking account. For example, as seen in FIG. 6, the user may be required to input a password, a passcode, or the like.

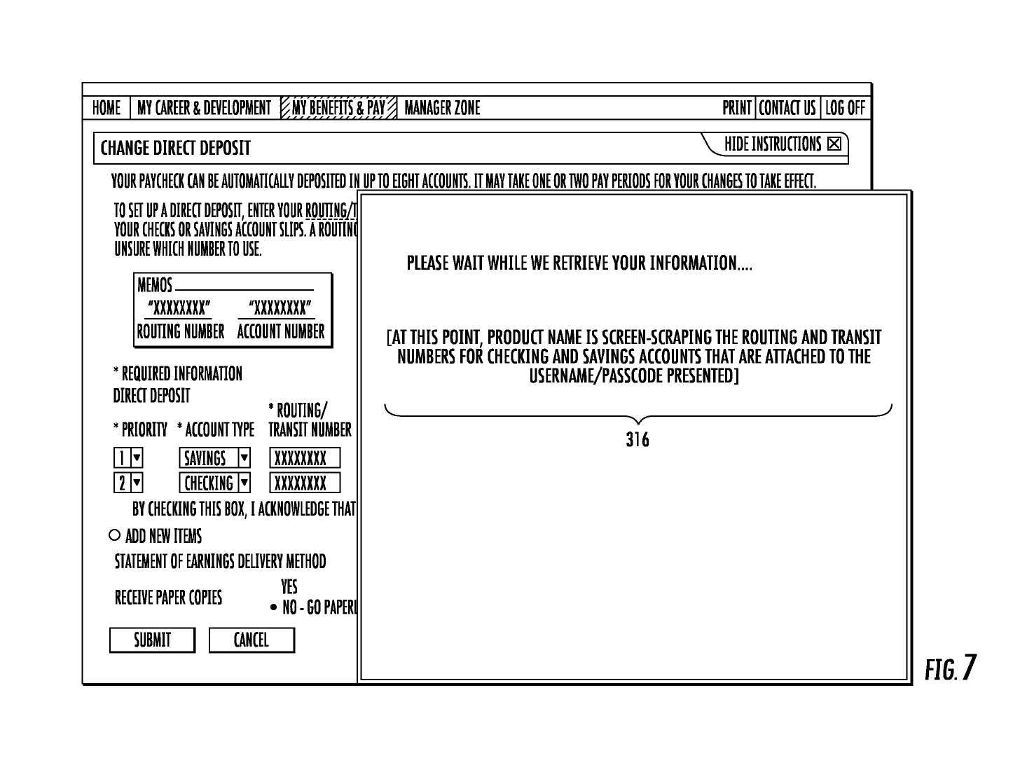

Upon successful entry of the user's online banking credentials, the apparatus may present to the user a wait message 316 as it retrieves the user's account information as displayed in FIG. 7. The apparatus may automatically retrieve the user's information associated with his financial entity. For example, the apparatus may automatically retrieve the user's transit or routing number, an account number, or the like for one or more of the user's accounts. In some embodiments, the apparatus may collect information associated with multiple accounts or account types, such as a checking account and savings account.

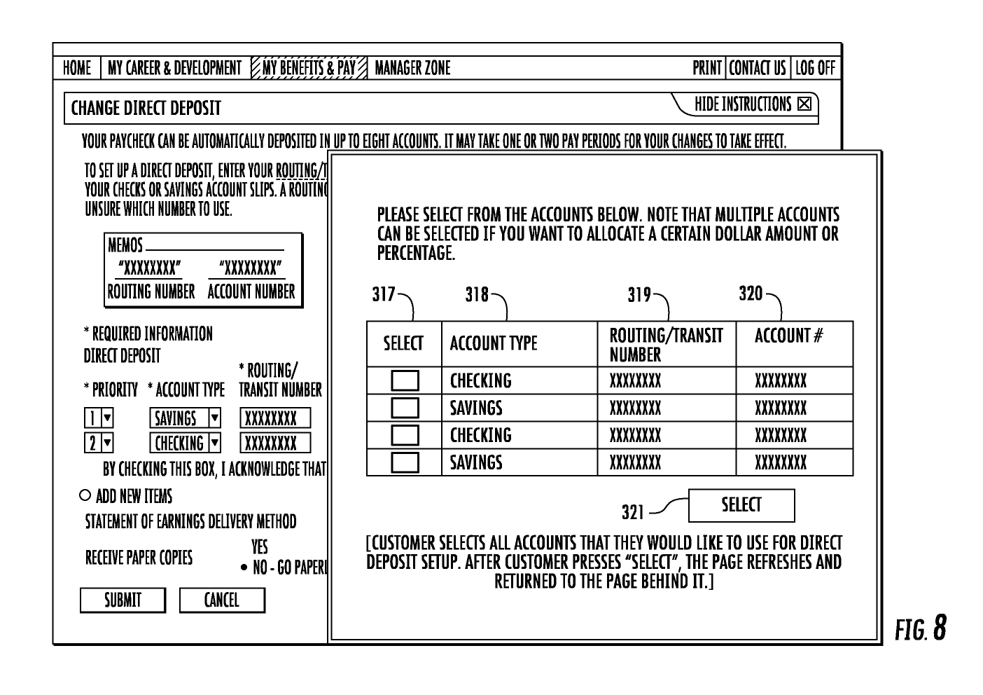

Once the apparatus has automatically retrieved the information associated with one or more of the user's accounts, the apparatus may present to the user an overview or summary of the collected information, as depicted in FIG. 8. The user may select via the Select 317 button which account to enroll in the direct deposit program as well as review the account type 318, the routing/transit number 319, and the account number 320 of each account. In some embodiments, the user may select one account. In other embodiments, the user may select multiple accounts. The Select 321 button confirms the user's account choices.

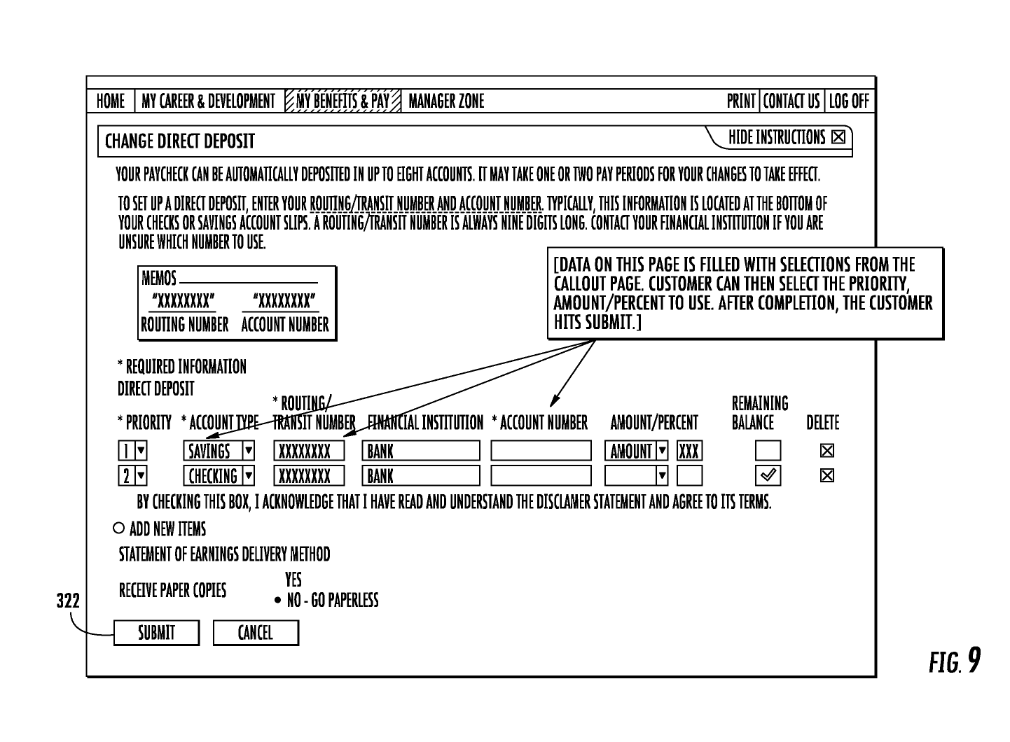

As shown in FIG. 9, the apparatus may automatically prefill the direct deposit summary with the confirmed account information. Thus, the present invention may enable the user to quickly and easily enroll in the direct deposit program without having to manually locate a routing/transit or account number associated with the user's banking account. This may not only save time for the user, it may also increase the number of users enrolled in the entity's direct deposit program. The user may submit the information via tab 322.

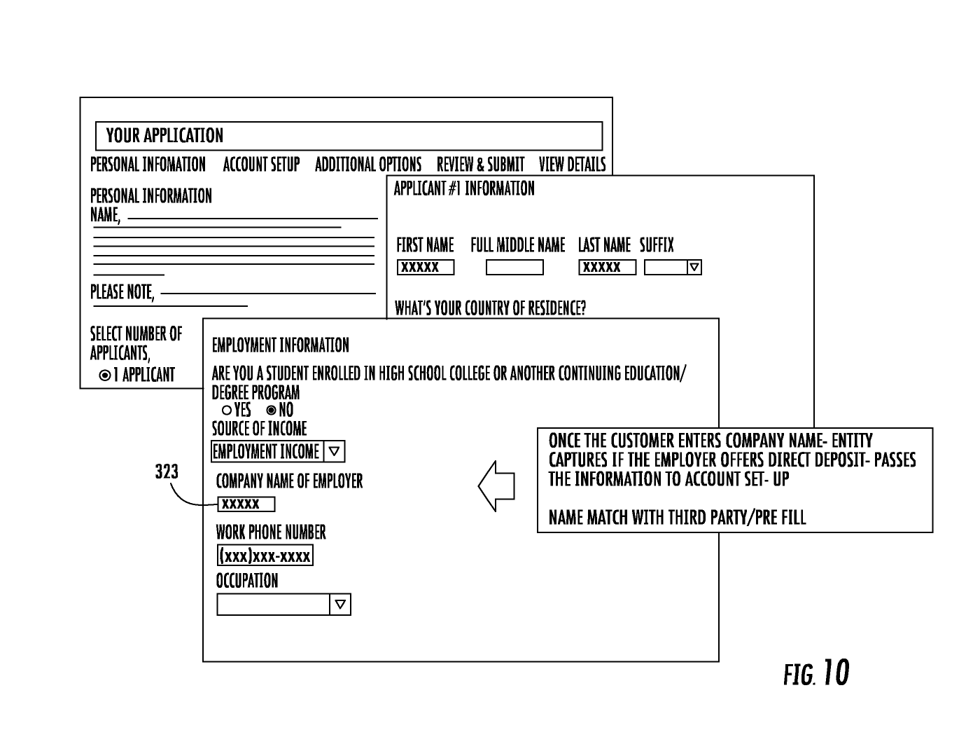

FIG. 10 illustrates an exemplary form that enables the user to input an employer name 323 as well as other information associated with the user's account, identity, or the like. The apparatus may be configured to automatically process the inputted employer name. Processing the inputted employer name may include comparing the inputted employer name to a table associated with either the entity or a third party payroll provider that includes names of employers who are known to participate in a direct deposit payroll program. If a match is determined, the user may be presented with an interface that enables the user to enroll an account in a direct deposit. The interface may include prefilled information associated with the employer.

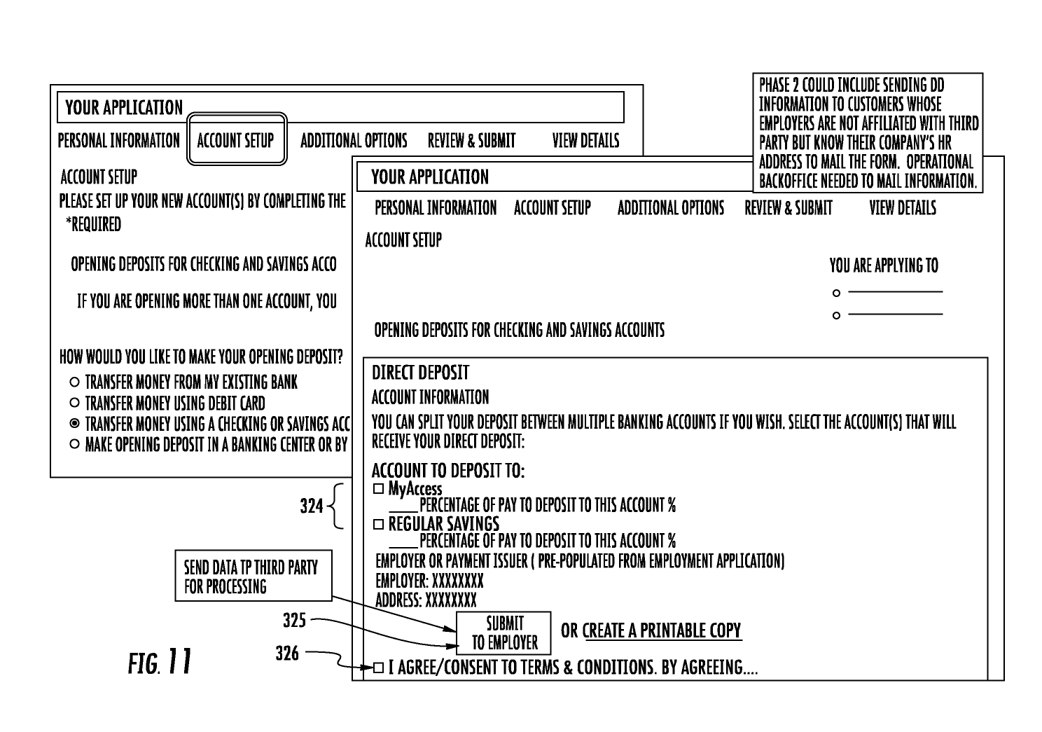

FIG. 11 is an exemplary interface for reviewing information associated with enrolling an account into a direct deposit program. The user may select which accounts to enroll via account selection tabs 324. Upon submission of the enrollment form via tab 325, information associated with the selected accounts may be transmitted to a third party payroll provider for processing and execution of enrolling the user into a direct deposit program. The user may be required to accept to a set of terms and conditions associated with transmitting account information to a third party payroll provider.

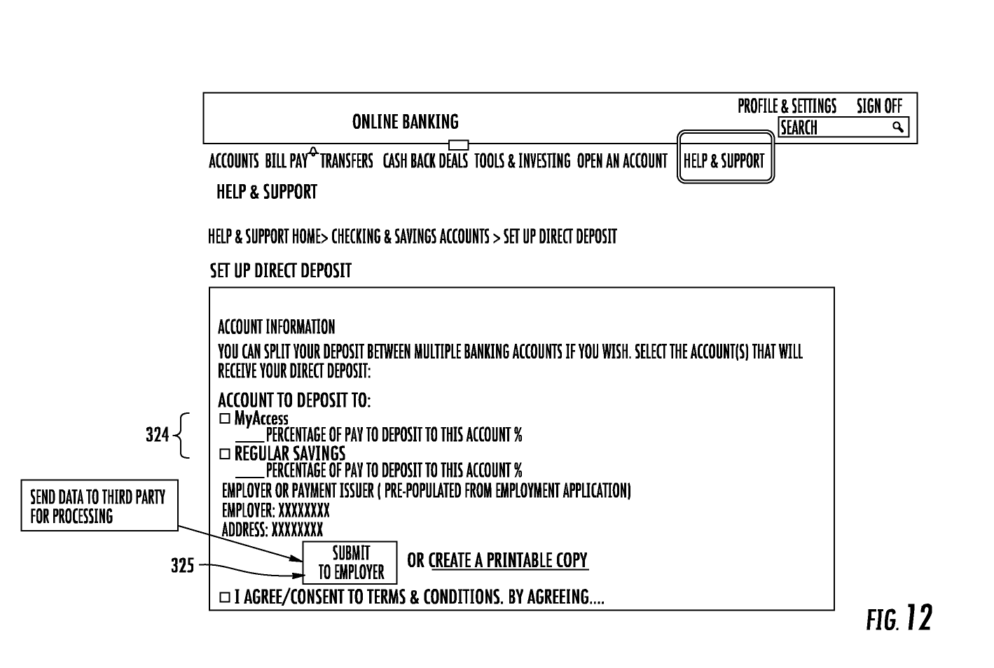

FIG. 12 is similar to FIG. 11 in functionality except that it is directed towards existing online banking customers. Existing customers may be enabled to enroll in a direct deposit program via the displayed interface.

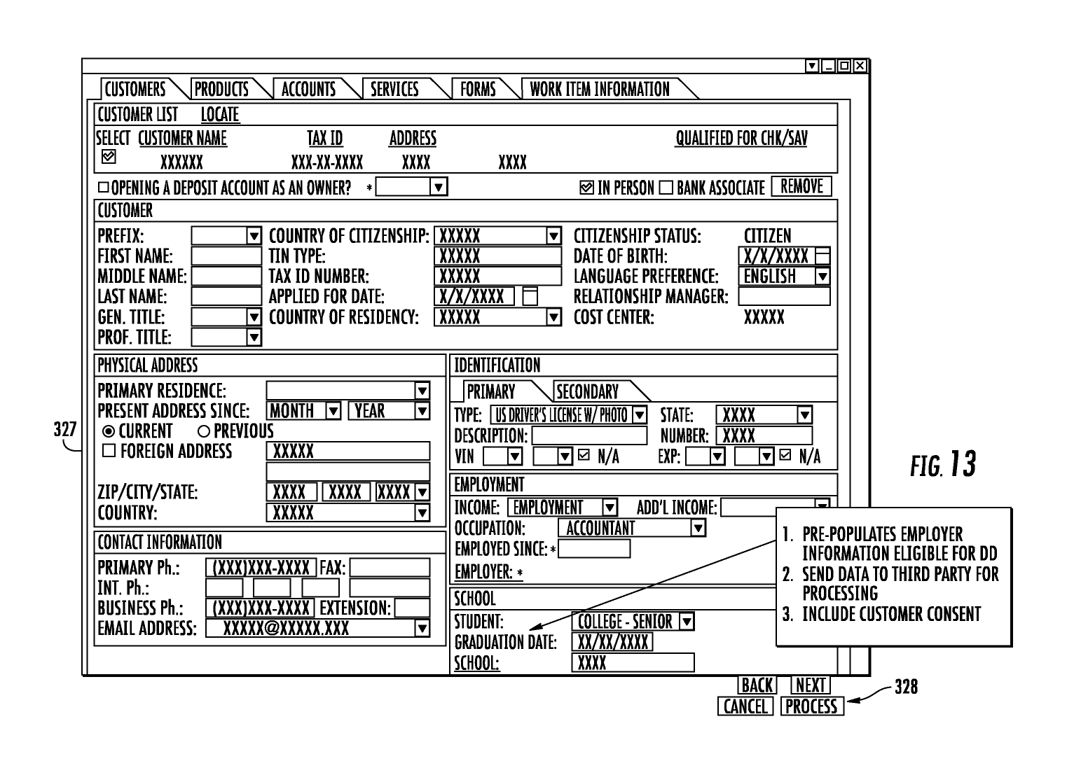

FIG. 13 illustrates an exemplary form that includes prefilled information 327 associated with the user's employer, as well as the user's account and personal information. Upon review, the user may submit via the Process tab 328 the information to a third party payroll provider for processing. The information included in FIG. 13 may be modified, edited, changed, added, or deleted by the user.

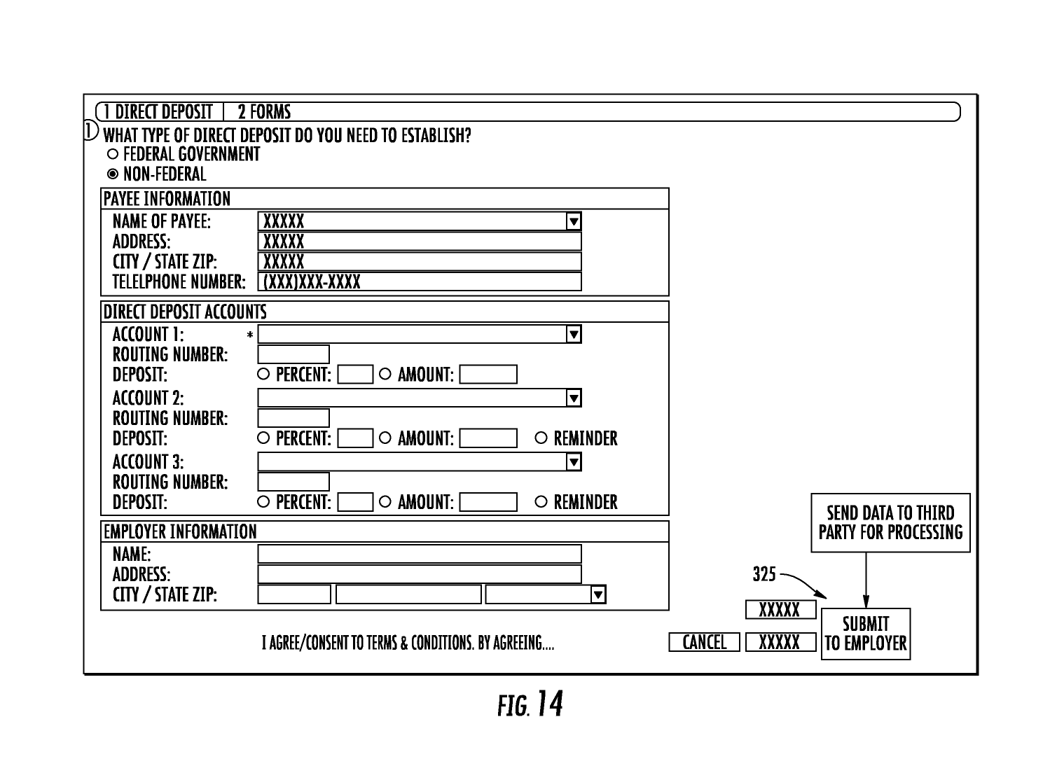

FIG. 14 illustrates an exemplary interface for reviewing information associated with the user's account. This account information may be submitted via tab 325 to a third party payroll provider for processing and enrollment into a direct deposit program.

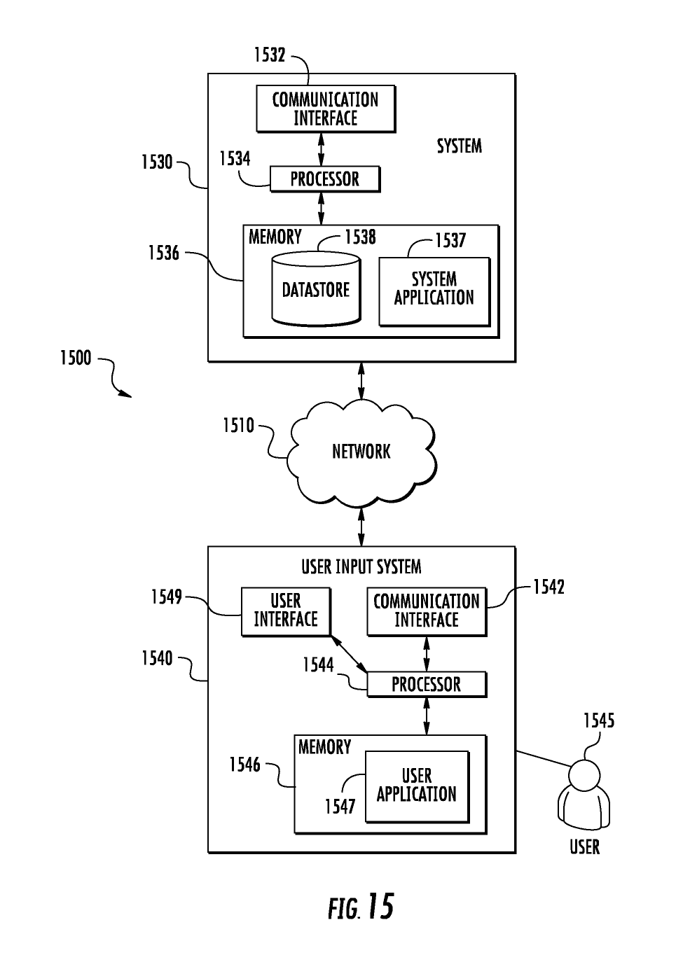

FIG. 15 presents an exemplary block diagram of the system environment 1500 for implementing the process flow described in FIGS. 1 and 2 in accordance with embodiments of the present invention. As illustrated, the system environment 1500 includes a network 1510, a system 1530, and a user input system 1540. Also shown in FIG. 15 is a user 1545 of the user input system 1540. The user input system 1540 may be a mobile device described herein. The user 1545 may be a person who uses the user input system 1540 to execute a user application 1547. The user application 1547 may be an application to communicate with the system 1530, perform a transaction, input information onto a user interface presented on the user input system 1540, or the like. The user application 1547 and/or the system application 1537 may incorporate one or more parts of any process flow described herein.

As shown in FIG. 15, the system 1530, and the user input system 1540 are each operatively and selectively connected to the network 1510, which may include one or more separate networks. In addition, the network 1510 may include a telecommunication network, local area network (LAN), a wide area network (WAN), and/or a global area network (GAN), such as the Internet. It will also be understood that the network 1510 may be secure and/or unsecure and may also include wireless and/or wireline and/or optical interconnection technology.

The user input system 1540 may include any computerized apparatus that can be configured to perform any one or more of the functions of the user input system 1540 described and/or contemplated herein. For example, the user 1545 may use the user input system 1540 to transmit and/or receive information or commands to and from the system 1530. In some embodiments, for example, the user input system 1540 may include a personal computer system (e.g. a non-mobile or non-portable computing system, a motor vehicle, or the like), a mobile computing device, a personal digital assistant, a mobile phone, a tablet computing device, a network device, and/or the like. As illustrated in FIG. 15, in accordance with some embodiments of the present invention, the user input system 1540 includes a communication interface 1542, a processor 1544, a memory 1546 having an user application 1547 stored therein, and a user interface 1549. In such embodiments, the communication interface 1542 is operatively and selectively connected to the processor 1544, which is operatively and selectively connected to the user interface 1549 and the memory 1546. In some embodiments, the user 1545 may use the user application 1547 to execute processes described with respect to the process flows described herein. Specifically, the user application 1547 executes the process flow described in FIGS. 1 and 2.

Each communication interface described herein, including the communication interface 1542, generally includes hardware, and, in some instances, software, that enables the user input system 1540, to transport, send, receive, and/or otherwise communicate information to and/or from the communication interface of one or more other systems on the network 1510. For example, the communication interface 1542 of the user input system 1540 may include a wireless transceiver, modem, server, electrical connection, and/or other electronic device that operatively connects the user input system 1540 to another system such as the system 1530. The wireless transceiver may include a radio circuit to enable wireless transmission and reception of information. Additionally, the user input system 1540 may include a positioning system. The positioning system (e.g. a global positioning system (GPS), a network address (IP address) positioning system, a positioning system based on the nearest cell tower location, or the like) may enable at least one of the user input system 1540 or an external server or computing device in communication with the user input system 1540 to determine the location (e.g. location coordinates) of the user input system 1540.

Each processor described herein, including the processor 1544, generally includes circuitry for implementing the audio, visual, and/or logic functions of the user input system 1540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 1547 of the memory 1546 of the user input system 1540.

Each memory device described herein, including the memory 1546 for storing the user application 1547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 15, the memory 1546 includes the user application 1547. The user application 1547 may be associated with various features of the device identification program. In some embodiments, the user application 1547 includes an interface for communicating with, navigating, controlling, configuring, and/or using the user input system 1540. In some embodiments, the user application 1547 includes computer-executable program code portions for instructing the processor 1544 to perform one or more of the functions of the user application 1547 described and/or contemplated herein. In some embodiments, the user application 1547 may include and/or use one or more network and/or system communication protocols.

Also shown in FIG. 15 is the user interface 1549. In some embodiments, the user interface 1549 includes one or more output devices, such as a display and/or speaker, for presenting information to the user 1545. In some embodiments, the user interface 1549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 1545. In some embodiments, the user interface 1549 includes the input and display devices of a mobile device, which are operable to receive and display information.

FIG. 15 also illustrates a system 1530, in accordance with an embodiment of the present invention. The system 1530 may refer to the “apparatus” described herein. The system 1530 may include any computerized apparatus that can be configured to perform any one or more of the functions of the system 1530 described and/or contemplated herein. In accordance with some embodiments, for example, the system 1530 may include a computer network, an engine, a platform, a server, a database system, a front end system, a back end system, a personal computer system, and/or the like. Therefore, the system 1530 may be a server managed by the entity. The system 1530 may be located at the facility associated with the entity or remotely from the facility associated with the entity. In some embodiments, such as the one illustrated in FIG. 15, the system 1530 includes a communication interface 1532, a processor 1534, and a memory 1536, which includes a system application 1537 and a datastore 1538 stored therein. As shown, the communication interface 1532 is operatively and selectively connected to the processor 1534, which is operatively and selectively connected to the memory 1536.

It will be understood that the system application 1537 may be configured to implement any one or more portions of the various user interfaces and/or process flow described herein. The system application 1537 may interact with the user application 1547. It will also be understood that, in some embodiments, the memory includes other applications. It will also be understood that, in some embodiments, the system application 1537 is configured to communicate with the datastore 1538, the user input system 1540, or the like.

It will be further understood that, in some embodiments, the system application 1537 includes computer-executable program code portions for instructing the processor 1534 to perform any one or more of the functions of the system application 1537 described and/or contemplated herein. In some embodiments, the system application 1537 may include and/or use one or more network and/or system communication protocols.

In addition to the system application 1537, the memory 1536 also includes the datastore 1538. As used herein, the datastore 1538 may be one or more distinct and/or remote datastores. In some embodiments, the datastore 1538 is not located within the system and is instead located remotely from the system. In some embodiments, the datastore 1538 stores information or data described herein. For example, the datastore 1538 may store information associated with the user's account.

It will be understood that the datastore 1538 may include any one or more storage devices, including, but not limited to, datastores, databases, and/or any of the other storage devices typically associated with a computer system. It will also be understood that the datastore 1538 may store information in any known way, such as, for example, by using one or more computer codes and/or languages, alphanumeric character strings, data sets, figures, tables, charts, links, documents, and/or the like. Further, in some embodiments, the datastore 1538 may include information associated with one or more applications, such as, for example, the system application 1537. It will also be understood that, in some embodiments, the datastore 1538 provides a substantially real-time representation of the information stored therein, so that, for example, when the processor 1534 accesses the datastore 1538, the information stored therein is current or substantially current.

It will be understood that the embodiment of the system environment illustrated in FIG. 9 is exemplary and that other embodiments may vary. As another example, in some embodiments, the system 1530 includes more, less, or different components. As another example, in some embodiments, some or all of the portions of the system environment 1500 may be combined into a single portion. Likewise, in some embodiments, some or all of the portions of the system 1530 may be separated into two or more distinct portions.

In addition, the various portions of the system environment 1500 may be maintained for and/or by the same or separate parties. It will also be understood that the system 1530 may include and/or implement any embodiment of the present invention described and/or contemplated herein. For example, in some embodiments, the system 1530 is configured to implement any one or more of the embodiments of the process flows described and/or contemplated herein in connection any process flow described herein. Additionally, the system 1530 or the user input system 1540 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for identifying participating employers in a direct deposit program, the apparatus comprising:
a memory;
a processor; and
a module stored in memory, executable by the processor, and configured to:
receive a first information from a user, wherein the first information includes an employer name;
compare the received employer name to a database of employer names that participate in a direct deposit program;
determine a match between the received employer name and an employer name that participates in a direct deposit program; and
prompt the user with an offer to enroll in a direct deposit program via an interface, in response to determining a match.

2. The apparatus of claim 1, wherein the first information is received via at least one of a wireless network, the Internet, and a satellite network.

3. The apparatus of claim 1, wherein the employer name includes a string of text characters.

4. The apparatus of claim 1, wherein prompting the user with an offer to enroll in a direct deposit program further comprises enrolling an account associated with the user in the direct deposit program.

5. The apparatus of claim 4, wherein the user may select which account to enroll in the direct deposit program.

6. The apparatus of claim 5, wherein the user may select multiple accounts to enroll in the direct deposit program.

7. The apparatus of claim 4, wherein the account is at least one of a savings account, a checking account, and an investment account.

8. The apparatus of claim 4, wherein enrolling the account associated with the user comprises enrolling the account using a third party payroll provider.

9. The apparatus of claim 1, wherein comparing the received employer name to a database of employer names that participate in a direct deposit program comprises transmitting the employee name to a second apparatus for processing.

10. The apparatus of claim 9, wherein the second apparatus is associated with a financial institution.

11. The apparatus of claim 9, wherein the second apparatus is associated with a third party payroll provider.

12. The apparatus of claim 9, wherein transmitting the employer name to a second apparatus further comprises transmitting information associated with the employer.

13. The apparatus of claim 1, wherein comparing the received employer name to a database of employer names that participate in a direct deposit program comprises comparing one or more strings of text characters.

14. The apparatus of claim 1, wherein the interface includes prefilled information.

15. The apparatus of claim 14, wherein the prefilled information is associated with the employer.

16. The apparatus of claim 14, wherein the prefilled information is associated with the user.

17. The apparatus of claim 14, wherein the prefilled information is associated with an account associated with the user.

18. The apparatus of claim 1, wherein in response to determining that there is no match between the received employer name and an employer name that participates in a direct deposit program the received employer name is input to the database.

19. A method for identifying participating employers in a direct deposit program, the method comprising:
receiving a first information from a user, wherein the first information includes an employer name;
comparing the received employer name to a database of employer names that participate in a direct deposit program;
determining a match between the received employer name and an employer name that participates in a direct deposit program; and
prompting the user with an offer to enroll in a direct deposit program via an interface, in response to determining a match.

20. A computer program product for identifying participating employers in a direct deposit program, the computer program product comprising a non-transitory computer-readable medium comprising code causing a computer to:
receive a first information from a user, wherein the first information includes an employer name;
compare the received employer name to a database of employer names that participate in a direct deposit program;
determine a match between the received employer name and an employer name that participates in a direct deposit program; and
prompt the user with an offer to enroll in a direct deposit program via an interface, in response to determining a match.
